(19) United States
(12) Patent Application Publication
(10) Pub. No.: US 2002/0105202 A1
(43) Pub. Date: Aug. 8, 2002

(54) Rear-door for vehicles

(76) Inventor: Amir Ziv-Av, Kiryat Ono (IL)

Correspondence Address: DR. MARK FRIEDMAN LTD., C/o Bill Polkinghorn, Discovery Dispatch, 9003 Florln Way, Upper Marlboro, MD, 20772, US

(21) Appl. No.: 10/062,446

(22) Filed: Feb. 5, 2002

(30) Foreign Application Priority Data
Feb. 6, 2001 (IL) 141279

(51) Int. Cl. B62D 25/00

(52) U.S. Cl. 296/56

(57) ABSTRACT

A rear door assembly for a vehicle includes a rear door surround and a door connected thereto by a mechanical linkage. The mechanical linkage is configured to selectively either retain the door in a closed state relative to the door surround, or to permit opening of the door in a pivoting motion about at least two, and preferably three, hinge axes selected from: a vertical axis adjacent to the right-hand edge; a vertical axis adjacent to the left-hand edge; and a horizontal axis adjacent to the upper edge.

### FIELD AND BACKGROUND OF THE INVENTION

The present invention relates to a door assembly and, in particular, it concerns a rear door assembly for vehicles which allows opening of the door selectively about a plurality of different axes.

Various door assemblies are known for use in vehicles having a near-vertical rear opening. A number of examples are illustrated in FIGS. 1A-1F. Specifically, FIG. 1A shows a split door with two halves of equal size each hinged about a vertical hinge axis at respective sides of the door surround. FIG. 1B shows a split door with a large part and a small part, each hinged about a vertical hinge axis. FIG. 1C shows a unitary door hinged to open about a vertical hinge axis. FIG. 1D shows a unitary door hinged to open upwards about a horizontal hinge axis. FIG. 1E shows a two-part door in which the upper part is implemented as a window which opens into the body of the lower part which is hinged to open downwards about a horizontal hinge axis. FIG. 1F shows a split door in which the upper part is hinged to open upwards about an upper horizontal hinge axis and the lower part is hinged to open downwards about a lower horizontal hinge axis.

Each of these types of door has various advantages and disadvantages. Specifically, a unitary door (FIGS. 1C and 1D) is generally preferred for its structural simplicity and for its contribution to the structural rigidity of the vehicle body when locked closed. The unitary door structure also facilitates straightforward sealing between the door and its surround, and permits a continuous fall-width rear window which is not possible in at least some of the split-door implementations. Despite these advantages, unitary rear doors present certain practical limitations. Specifically, a side opening door of the type illustrated in FIG. 1C limits the accessibility to the vehicle. For example, if the vehicle is parked against a right-side curb, the right-opening door of FIG. 1C may render it difficult or even impossible to load the vehicle from the sidewalk, requiring instead loading from the direction of the street with the accompanying inconvenience and risk. An upward opening door of the type shown in FIG. 1D avoids the problem of directionality, but is generally less convenient for the user who must contend with the weight of the door and/or the biasing forces of the counterbalancing system provided to retain the door in its raised position.

There is therefore a need for a unitary rear door assembly for a vehicle which would avoid the accessibility limitations or inconvenience of the existing systems.

### SUMMARY OF THE INVENTION

The present invention is rear door assembly for a vehicle.

According to the teachings of the present invention there is provided, a rear door assembly for a vehicle, the rear door assembly comprising: (a) a rear door surround having an upper edge, a right-hand edge and a left-hand edge; (b) a door; and (c) a mechanical linkage interconnecting between the door surround and the door, the mechanical linkage being configured to selectively: (i) retain the door in a closed state relative to the door surround, (ii) permit opening of the door in a pivoting motion about a first hinge axis, and (iii) permit opening of the door in a pivoting motion about a second hinge axis, wherein the first and the second hinge axes are two different axes from the group made up of: a vertical axis adjacent to the right-hand edge; a vertical axis adjacent to the left-hand edge; and a horizontal axis adjacent to the upper edge.

According to a further feature of the present invention, the first hinge axis is the vertical axis adjacent to the right-hand edge and the second hinge axis is the vertical axis adjacent to the left-hand edge.

According to a further feature of the present invention, the door has a dimension D₁ as measured perpendicular to the first hinge axis and a dimension D₂ as measured perpendicular to the second hinge axis, the door including a first handle associated with the door at a position at least two thirds of D₁ away from the first hinge axis and configured to actuate the mechanical linkage so as to release the door from the closed state to permit opening of the door in a pivoting motion about the first hinge axis, the door further including a second handle associated with the door at a position at least two thirds of D₂ away from the second hinge axis and configured to actuate the mechanical linkage so as to release the door from the closed state to permit opening of the door in a pivoting motion about the second hinge axis.

According to a further feature of the present invention, the mechanical linkage includes an intermediate frame deployed between the door surround and the door, wherein the door is pivotally mounted to the intermediate frame so as to be pivotable about the first hinge axis and the intermediate frame is pivotally mounted to the door surround so as to be pivotable about the second hinge axis. Preferably, the second hinge axis is perpendicular to the first hinge axis.

According to a further feature of the present invention, the mechanical linkage further includes at least one biasing mechanism deployed so as to bias the door relative to the intermediate frame to remain in an upwardly pivoted open position.

According to a further feature of the present invention, the intermediate frame extends around substantially the entirety of the door surround.

According to an alternative feature of the present invention, the intermediate frame extends around only part of the door surround.

According to a further feature of the present invention, the intermediate frame is substantially hidden by the door when the door assumes the closed state.

According to an alternative feature of the present invention, the intermediate frame is implemented as a secondary door surround within which the door is positioned in the closed state.

According to a further feature of the present invention, the first hinge axis is a vertical axis adjacent to the right-hand edge, the second hinge axis is a vertical axis adjacent to the left-hand edge, and wherein the mechanical linkage is further configured to selectively permit opening of the door in a pivoting motion about a horizontal hinge axis adjacent to the upper edge.

According to a further feature of the present invention, the door has a dimension D₁ as measured perpendicular to the first and the second hinge axes and a dimension D₂ as measured perpendicular to the horizontal hinge axis, the door including a left handle associated with the door at a position at least two thirds of D₁ away from the first hinge axis and configured to actuate the mechanical linkage so as to release the door from the closed state to permit opening of the door in a pivoting motion about the first hinge axis, the door further including a right handle associated with the door at a position at least two thirds of D₁ away from the second hinge axis and configured to actuate the mechanical linkage so as to release the door from the closed state to permit opening of the door in a pivoting motion about the second hinge axis, and the door further including a bottom handle associated with the door at a position at least two thirds of D₂ away from the horizontal hinge axis and configured to actuate the mechanical linkage so as to release the door from the closed state to permit opening of the door in a pivoting motion about the horizontal hinge axis.

### BRIEF DESCRIPTION OF THE DRAWINGS

The invention is herein described, by way of example only, with reference to the accompanying drawings, wherein:

FIGS. 1A-1F are schematic isometric views of prior art rear door assemblies for vehicles;

FIG. 2A is a schematic isometric view of a rear door assembly, constructed and operative according to the teachings of the present invention, shown in a closed state;

FIG. 2B is a schematic isometric view of the rear door assembly of FIG. 2A opened about a right-hand vertical hinge axis;

FIG. 2C is a schematic isometric view of the rear door assembly of FIG. 2A opened about a left-hand vertical hinge axis;

FIG. 2D is a schematic isometric view of the rear door assembly of FIG. 2A opened about a horizontal hinge axis;

FIG. 3A is a schematic isometric view of a first preferred implementation of the rear door assembly of FIG. 2A employing an intermediate frame;

FIG. 3B is an enlarged view of the region of FIG. 3A designated “A”;

FIG. 3C is an enlarged view of the region of FIG. 3A designated “B”;

FIG. 4A is a rear view of the rear door assembly of FIG. 3A;

FIG. 4B is a side view of the rear door assembly of FIG. 3A;

FIG. 4C is a top view of the rear door assembly of FIG. 3A;

FIG. 4D is an interior isometric view of the rear door assembly of FIG. 3A;

FIG. 4E is a lower isometric view of the rear door assembly of FIG. 3A;

FIG. 4F is an enlarged view of the region of FIG. 4E designated “C”

FIG. 5A is a view similar to FIG. 3A in which the left-hand handle has been actuated;

FIG. 5B is an enlarged view of the region of FIG. 5A designated “A”;

FIG. 6 is a view similar to FIG. 3A during opening of the door about a hinge axis adjacent to the right-hand-side of the door surround;

FIG. 7 is a view similar to FIG. 3A with the door opened about a hinge axis adjacent to the right-hand-side of the door surround;

FIG. 8 is a view similar to FIG. 3A with the door opened about a hinge axis adjacent to the left-hand-side of the door surround;

FIG. 9A is a side view of the rear door assembly of FIG. 3A in which the lower handle has been actuated;

FIG. 9B is an enlarged view of the region of FIG. 9A designated “A”;

FIG. 10 is a view similar to FIG. 9A during opening of the door about an upper horizontal hinge axis;

FIG. 11 is a schematic isometric view of the rear door assembly of FIG. 3A with the door opened about an upper horizontal hinge axis;

FIG. 12A is a schematic isometric view of a preferred simplified implementation of the rear door assembly of FIG. 2A for providing two-way opening about vertical hinge axes on opposite sides of the door;

FIG. 12B is an enlarged view of the region of FIG. 12A designated

FIG. 12C is an enlarged view of the region of FIG. 12A designated “B”;

FIG. 13A is a view similar to FIG. 12A in which the left-hand handle has been actuated;

FIG. 13B is an enlarged view of the region of FIG. 13A designated “A”;

FIG. 13C is an enlarged view of the region of FIG. 13A designated “B”;

FIG. 14 is a view similar to FIG. 12A with the door opened about a hinge axis adjacent to the right-hand-side of the door surround;

FIG. 15 is a view similar to FIG. 12A with the door opened about a hinge axis adjacent to the left-hand-side of the door surround;

FIG. 16 is a schematic side view of a third preferred implementation of the rear door assembly of FIG. 2A for providing three-way opening of the door;

FIG. 17A is a schematic rear isometric view of the door from the rear door assembly of FIG. 16;

FIG. 17B is an enlarged view of the region designated “A” in FIG. 17A;

FIG. 18A is a view similar to FIG. 17A in which the left-hand handle (as viewed from outside) has been actuated;

FIG. 18B is a side isometric view of the door of FIG. 18A;

FIG. 19 is an isometric view of the rear door assembly of FIG. 16 during opening of the door about a hinge axis adjacent to the right-hand-side of the door surround;

FIG. 20 is an isometric view of the rear door assembly of FIG. 16 with the door opened about a hinge axis adjacent to the right-hand-side of the door surround;

FIG. 21 is an isometric view of the rear door assembly of FIG. 16 with the door opened about a hinge axis adjacent to the left-hand-side of the door surround;

FIG. 22 is a schematic rear isometric view of the door from the rear door assembly of FIG. 16 in which the lower handle has been actuated;

FIGS. 23A and 23B are enlarged schematic isometric views of the lower part of the door of FIG. 22 illustrating a possible implementation of a selectively engagable lower handle linkage in its disengaged and engaged actuated states, respectively; and

FIG. 24 is a schematic isometric view of the rear door assembly of FIG. 16 with the door opened about an upper horizontal hinge axis.

### DESCRIPTION OF THE PREFERRED EMBODIMENTS

The present invention is a rear door assembly for vehicles.

The principles and operation of rear door assemblies according to the present invention may be better understood with reference to the drawings and the accompanying description.

Referring now to the drawings, FIGS. 2A-2D show schematically a rear door assembly, generally designated 10, constructed and operative according to the teachings of the present invention, for use at the rear of a vehicle such as a van, station wagon or utility vehicle. Generally speaking, rear door assembly 10 includes a rear door surround 12 having an upper edge 14, a right-hand edge 16 and a left-hand edge 18. A door 20 is connected to the door surround 12 by a mechanical linkage, various examples of which will be provided below. The mechanical linkage being configured to selectively either retain the door in a closed state relative to the door surround (FIG. 2A), or to permit opening of the door in a pivoting motion about at least two, and preferably three, hinge axes selected from: a vertical axis adjacent to the right-hand edge (FIG. 2B); a vertical axis adjacent to the left-hand edge (FIG. 2C); and a horizontal axis adjacent to the upper edge (FIG. 2D).

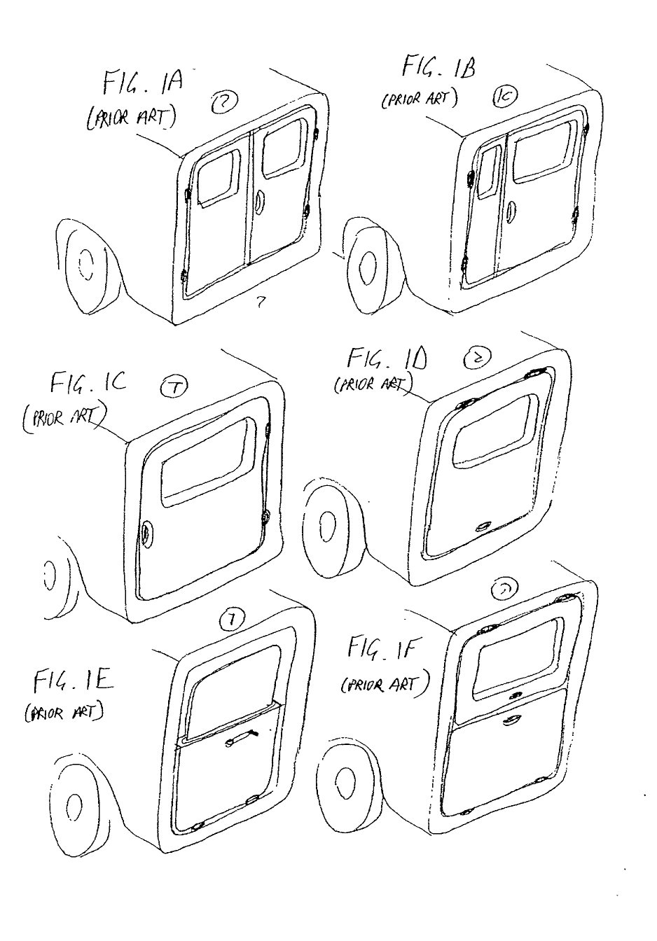

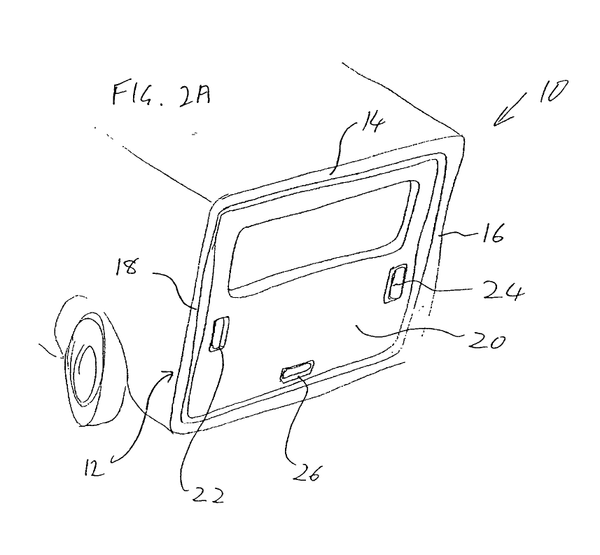

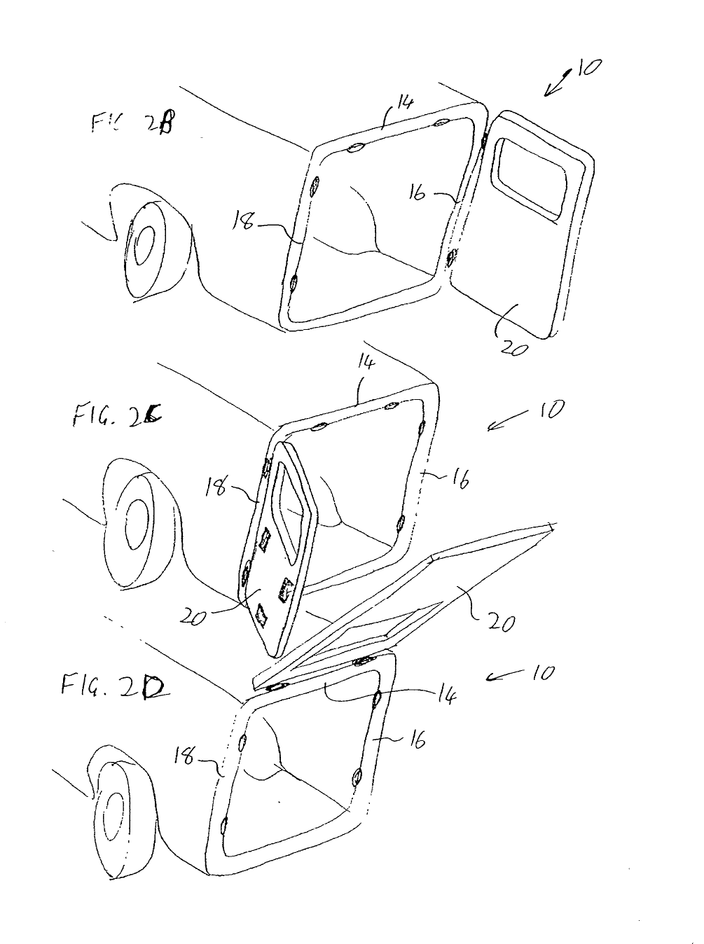

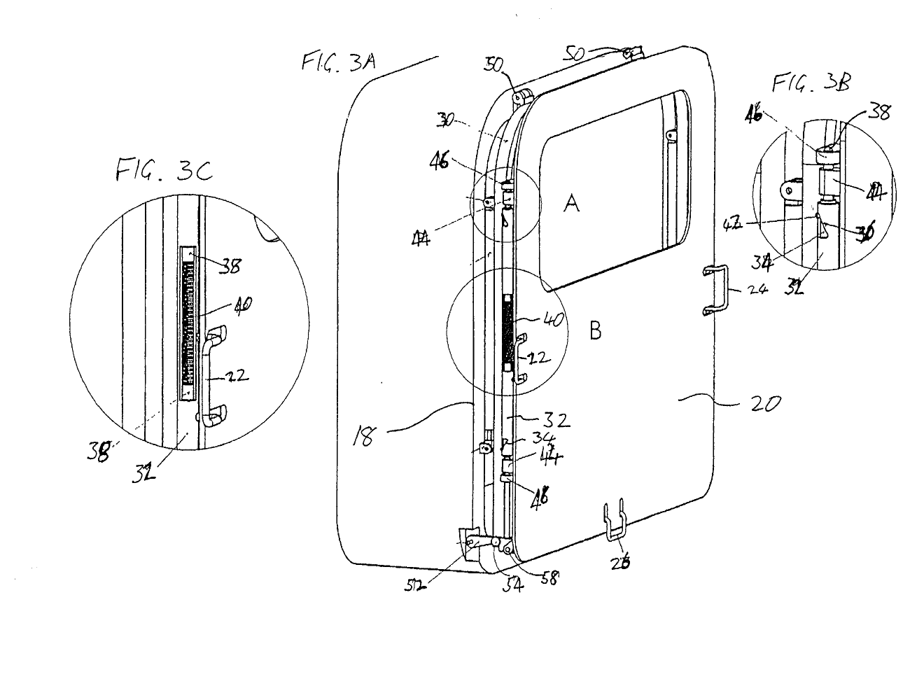

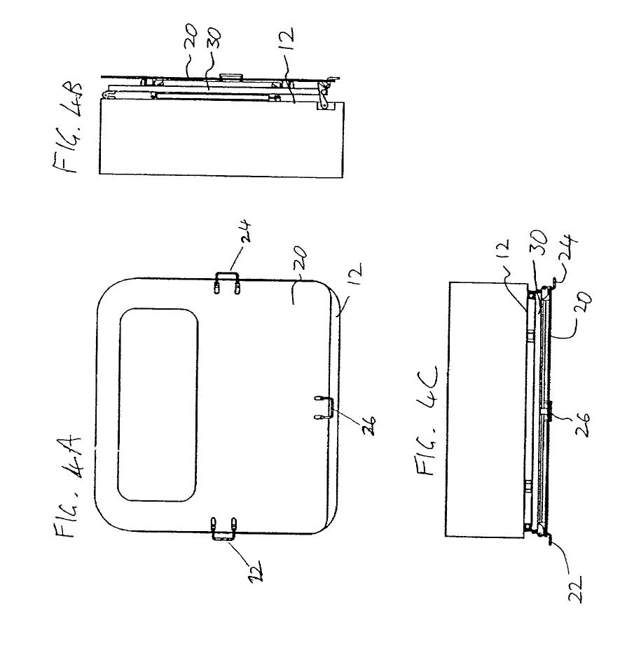

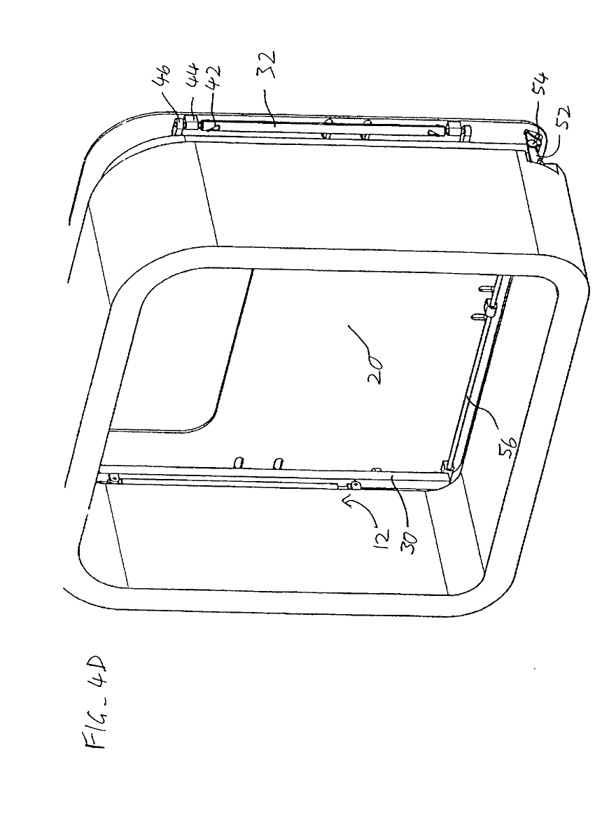

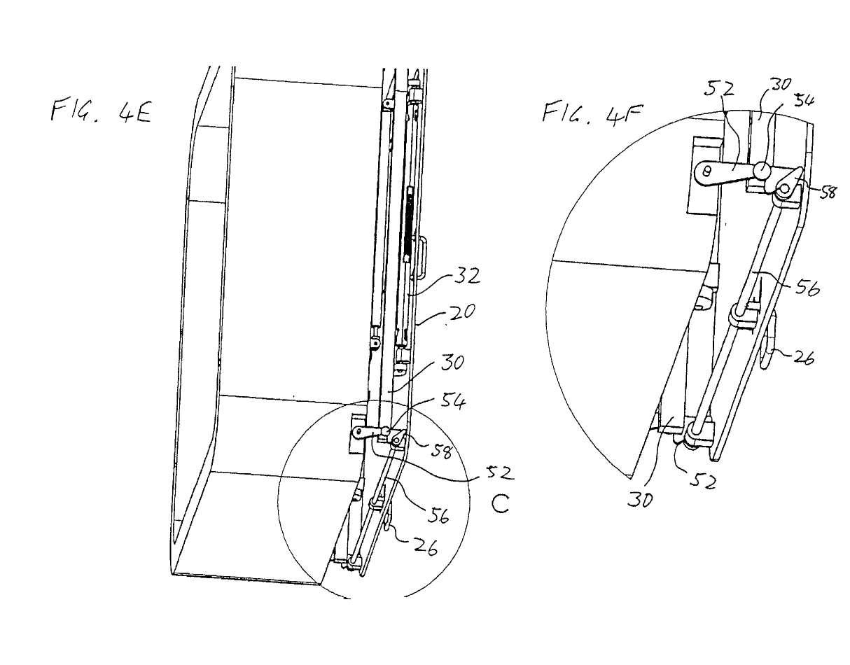

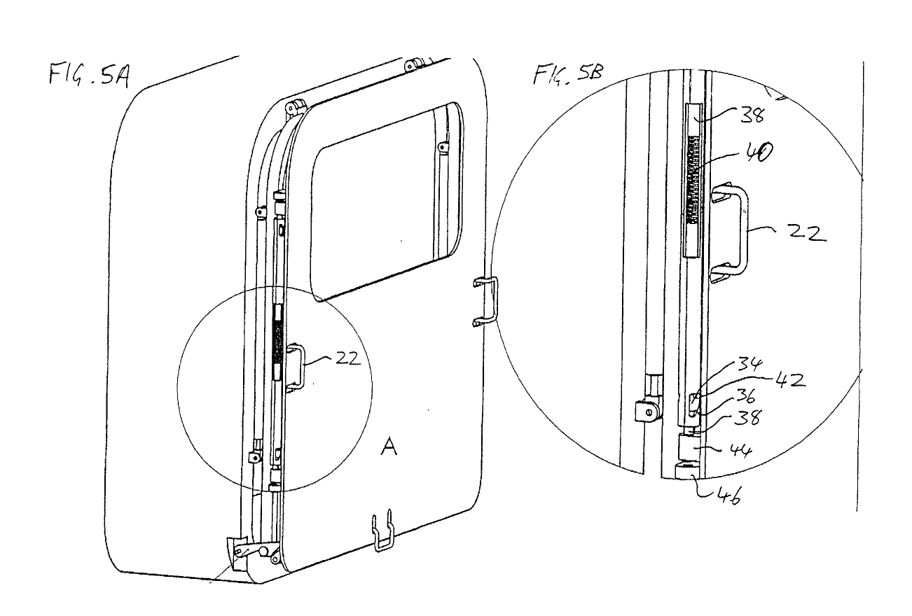

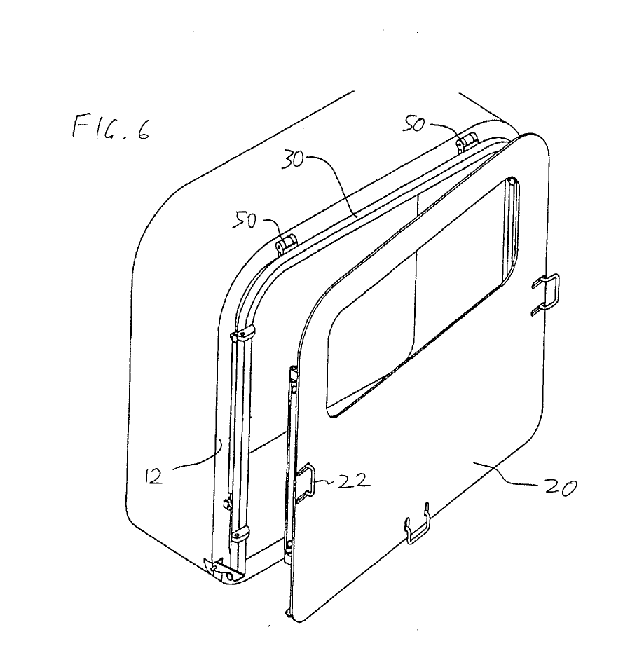

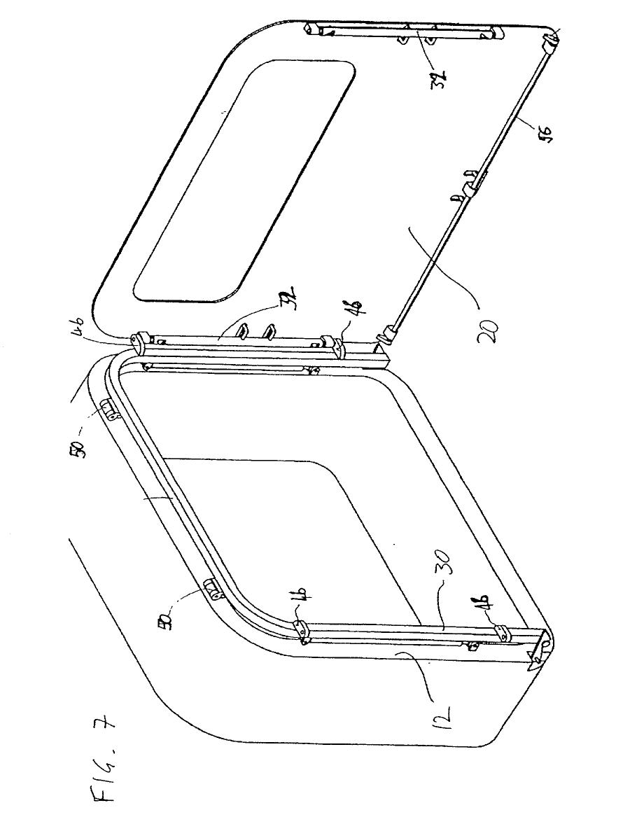

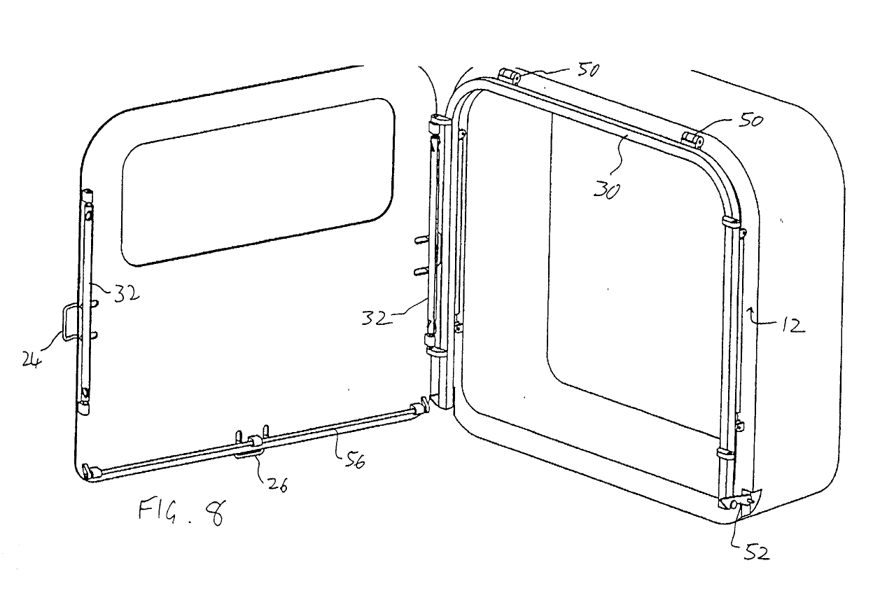

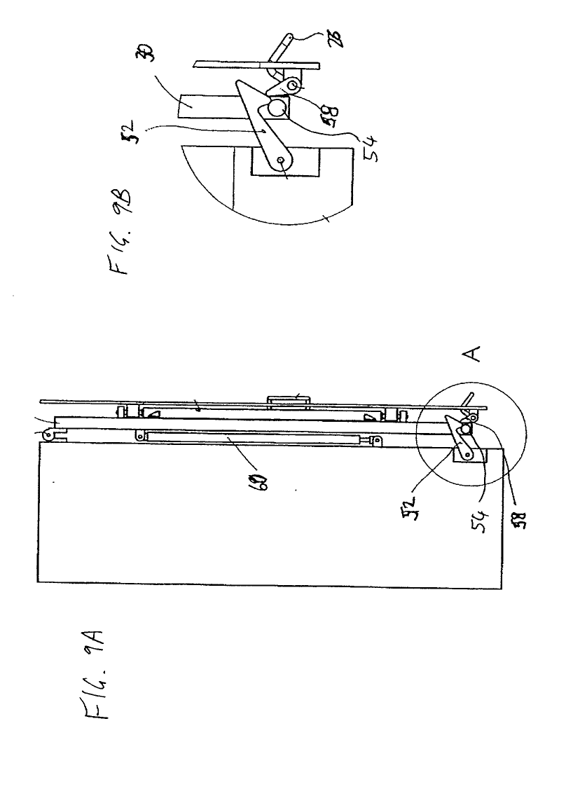

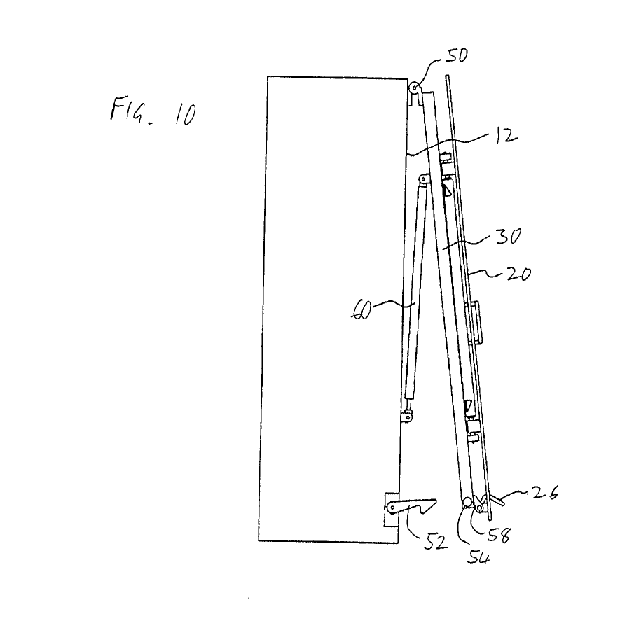

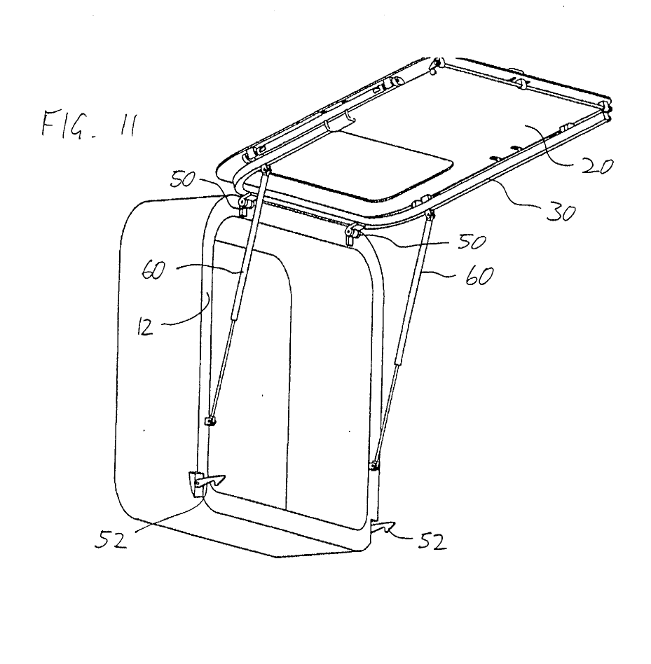

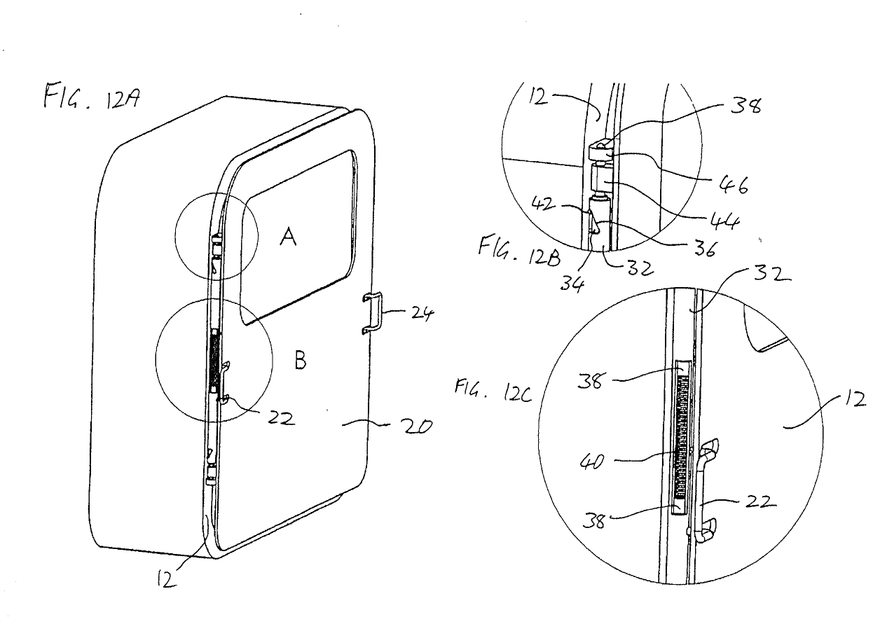

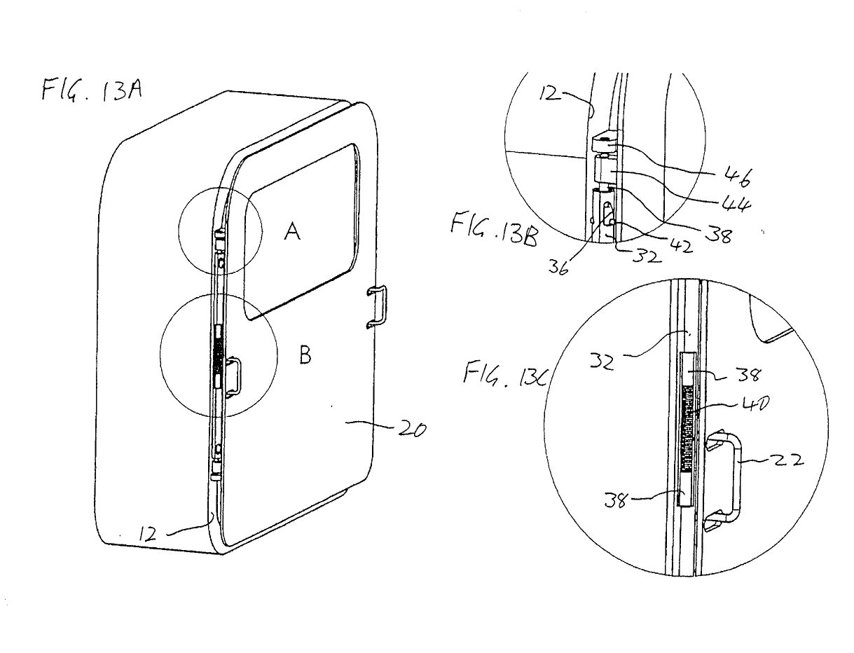

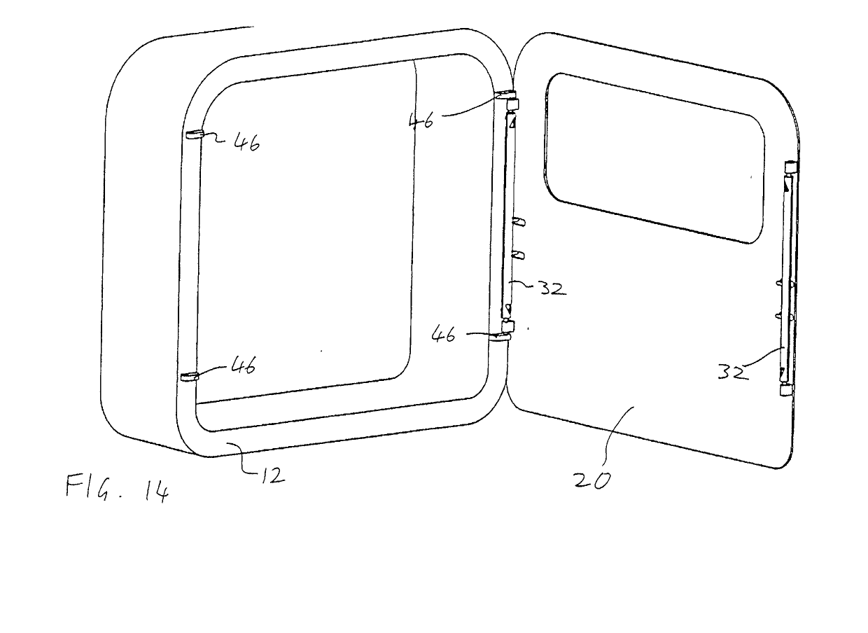

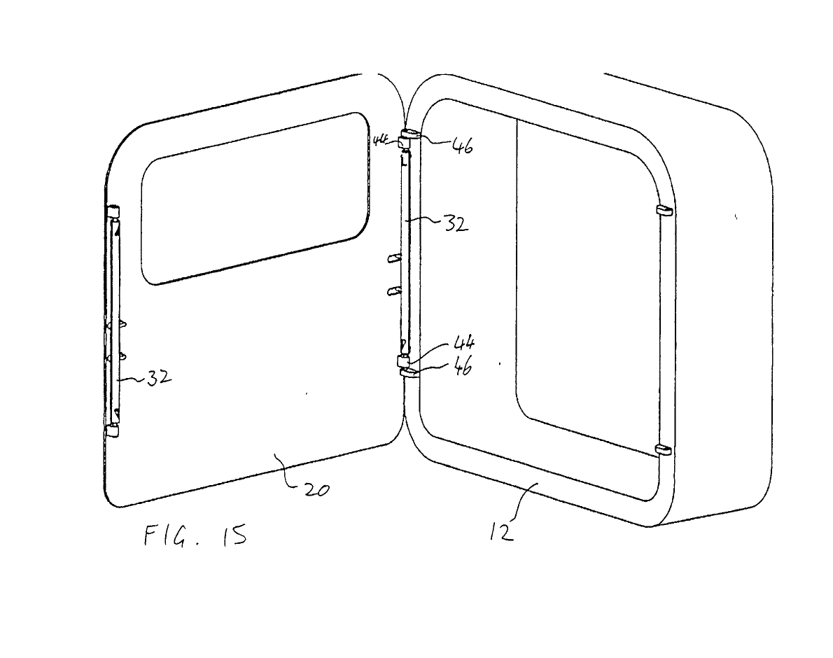

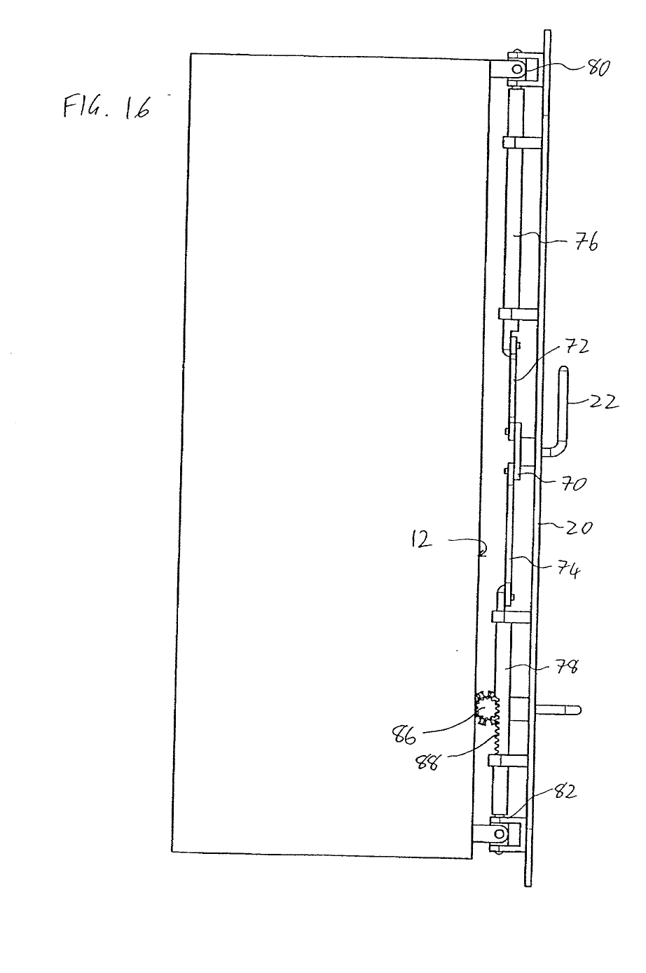

It will be readily apparent that rear door assembly 10 provides profound advantages over the prior art systems of FIGS. 1A-1F. Specifically, the assembly provides a unitary door structure while at the same time avoiding the accessibility problems of one-directional opening doors. Thus, for example, when alongside a left-hand-side curb, the rightward opening of FIG. 2B may be used while, when alongside a right-hand-side curb, the leftward of FIG. 2C may be used. In other circumstances, the upward opening of FIG. 2D may be preferred. These and other advantages of the present invention will become clearer from the following description.

According to one particularly preferred feature of the present invention, door 20 is provided with at least two separate handles (22, 24, 26) each associated with the mechanical linkage so as to selectively open the door about one of the aforementioned hinges. Each handle is preferably located at least two-thirds of the width or height (whichever is perpendicular to the hinge axis) from the respective hinge axis such that it is intuitively associated with the corresponding mode of opening and well placed ergonomically for applying the required opening moment on the door. Thus, in the case shown here, left handle 22 actuates the rightward opening of FIG. 2B, right handle 24 actuates the leftward opening of FIG. 2C and lower handle 26 actuates the upward opening of FIG. 2D. Most preferably, the handle for each hinge axis is located at least four fifths of the corresponding dimension from the corresponding hinge axis.

It should be appreciated that the principles of the present invention may be implemented using various different implementations of the mechanical linkage. For the purpose of illustrating the principles of certain implementations, a small number of non-limiting examples will be described herein. However, various other implementations will be clear to one ordinarily skilled in the art.

Turning now to FIGS. 3A-11, a first preferred implementation of rear door assembly 10 will be presented schematically. According to this implementation, the mechanical linkage includes an intermediate frame 30 deployed between door surround 12 and door 20 to isolate at least two of the different hinge axes mechanically. Specifically, door 20 is pivotally mounted to intermediate frame 30 so as to be pivotable about a first hinge axis and intermediate frame 30 is in turn pivotally mounted to door surround 12 so as to be pivotable about a second hinge axis.

Particularly in a preferred case where the first and second hinge axes are mutually perpendicular, this family of implementations offers a mechanically simple solution to implementation of the invention. In the case of a three-way implementation, the subdivision of axes is preferably between the horizontal hinge axis on one side of the frame and the two vertical axes on the other.

By way of a non-limiting example, the embodiment shown here has the two vertical axis hinges between intermediate frame 30 and door 20, and the horizontal axis hinge between the frame and the door surround 12. It will be clear, however, that this sequence may readily be reversed according to various design considerations.

Further by way of non-limiting example, the invention is here illustrated in a preferred embodiment in which intermediate frame 30 is implemented as a hidden or substantially hidden element lying behind door 20 when closed. In an alternative set of implementations (not shown), intermediate frame 30 is implemented as a secondary door surround within which door 20 is positioned in the closed state. In this case, door 20 and intermediate frame 30 function as a door within a door hinging about different axes.

By way of a final introduction to this implementation, intermediate frame 30 is here shown as an open frame extending around only part of door surround 12. Depending upon the degree of structural rigidity required of the frame, this structure may be expanded to form a closed frame extending around substantially the entirety of the door surround. In cases where sufficient structural rigidity is offered by the door itself in its closed position, it may be possible to further reduce the open intermediate frame to two or more disjoint intermediate brackets.

Turning now to the structural features of the implementation of FIGS. 3A-11 in more detail, each side handle 22, 24 is linked so as to turn a vertical cylinder 32 which has cut-outs 34 with an inclined slot edge 36 near its upper and lower ends. Within each cylinder 32 are upper and lower locking pins 38 which are biased apart by one or more spring 40, and which have lateral projections 42 engaged within the corresponding cut-out 34. Each locking pin 38 also passes through a support block 44 which allows axial displacement but prevents rotation relative to door 20. The ends of locking pins 38 engage support blocks 46 attached to intermediate frame 30, acting as a hinge axis which retains the left side of door 20 against intermediate frame 30.

When left handle 22 is rotated (FIGS. 5A and 5B), cylinder 32 turns, thereby causing slot edges 36 to bear on lateral projections 42 so as to withdraw locking pins 38 towards cylinder 32 against spring 40 until the locking pins are released from support blocks 46. The door 20 may then be opened as shown in FIGS. 6 and 7 with the similar structure on the right side of the door providing a vertical hinge axis adjacent to the right side 16 of door surround 12.

In a similar manner, operation of right handle 24 releases locking pins 38 from the assembly on the right side of the door while the left hand side remains engaged to provide leftwards hinged opening of door 20 relative to intermediate frame 30 as shown in FIG. 8. Preferably, a safety mechanism (not shown) prevents inadvertent simultaneous operation of both release mechanisms.

Preferably, the end surfaces of locking pins 38 and the surfaces of support blocks 46 are shaped such that locking pins retract out of the way automatically as the door 20 is returned to its closed position. Cut outs 34 are also formed with a triangular shape as shown such that they can accommodate the aforementioned retraction of locking pins 38 during closing of the door without requiring rotation of the handle 22 or 24.

Turning now to the upward opening of door 20, as mentioned earlier, this is implemented here by a separate hinged connection between intermediate frame 30 and door surround 12. Specifically, intermediate frame 30 is attached to door surround 12 at upper hinges 50, and retained in its closed position by engagement of sprung hook latches 52 on projecting pins 54 of frame 30 (see FIGS. 4E and 4F). Release of hook latches 52 by lower handle 26 is achieved by rotation of a lower crossbar 56 associated with the handle 26 which carries two cam actuators 58. Actuation of lower handle 26 brings cam actuators 58 to bear on latches 52 as shown in FIGS. 9A and 9B, thereby releasing intermediate frame 30 and door 20 which it carries to be raised as shown in FIGS. 10 and 11. At least one biasing mechanism (e.g., spring elements 60) are preferably deployed between door surround 12 and intermediate frame 30 to bias the door relative to the intermediate frame to remain in an upwardly pivoted open position and to assist the user in raising the door, as is known in the art.

Here too, hook latches 52 are preferably configured to automatically ride over projection pins 54 when the door is closed, thereby allowing the frame to return to its locked position when closed.

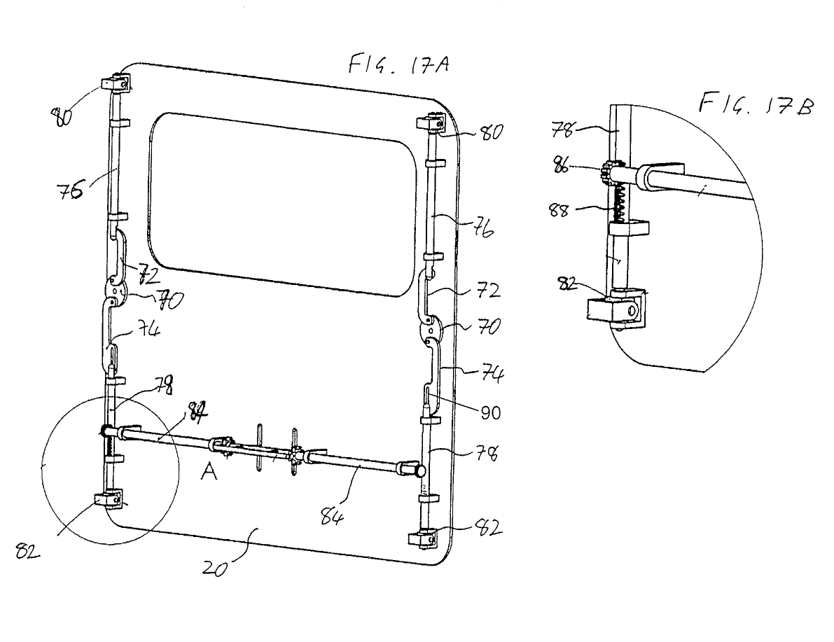

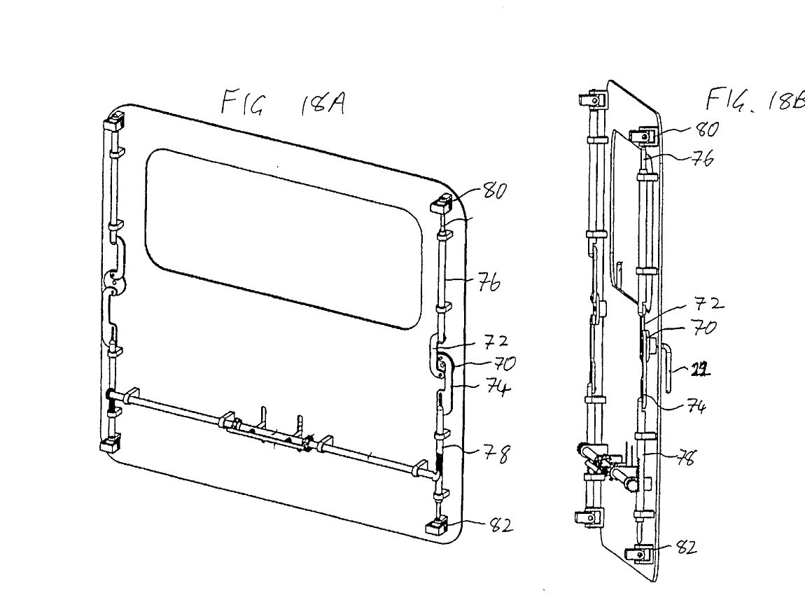

Turning now to FIGS. 12A-15, there is shown a simple implementation of the present invention in which door 20 opens around only two hinge axes. In a preferred case, the two axes are chosen to be a vertical axis adjacent to right-hand edge 16 and a vertical axis adjacent to left-hand edge 18. This is sufficient to provide a solution to the problem of loading and unloading from a curb on either side of the vehicle, rendering this a particularly attractive solution for cases where cost limitations or various design considerations require a simpler implementation.

Structurally, the implementation of FIGS. 12A-15 is identical to the outer half of the structure described above with reference to FIGS. 3A-11. In other words, this implementation may be viewed as a variation of the above implementation in which support blocks 48 are mounted directly to door surround 12 rather than to frame 30. The structural details and operation of this implementation will thus be fully understood by reference to the relevant portions of the description above.

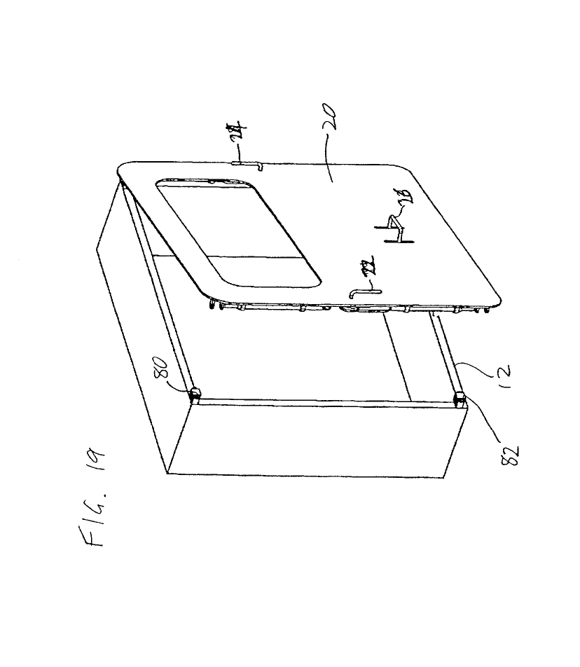

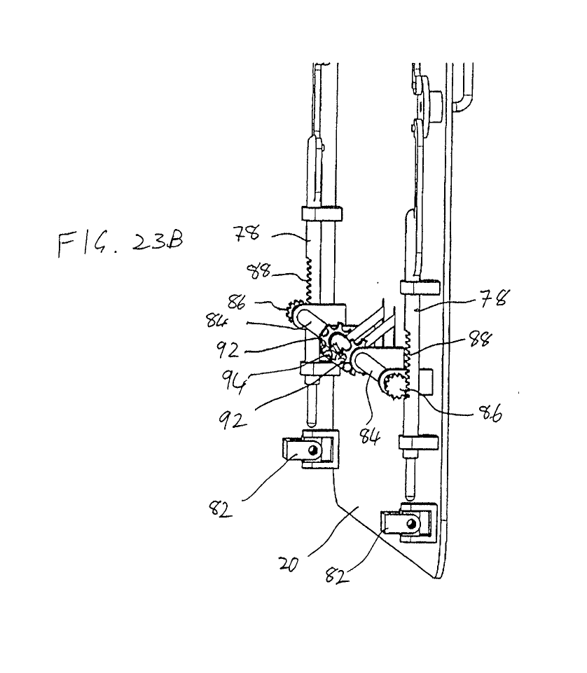

Turning finally to the implementation of FIGS. 16-24, it should be noted that it is also possible to implement the three-way opening door of the present invention without use of an intermediate frame. In the example shown here, this is achieved by providing upper connections which serve as universal joints, functioning as hinges with respect to rotation about either a horizontal or vertical axis. The three-way opening can then be achieved by providing a mechanism for selectively disconnecting the appropriate two out of four points of attachment. Details of one such mechanism will now be described.

Referring first to FIGS. 17A-18B, each side handle 22 and 24 is associated with a rotatable bracket, implemented here as disk 70. Rotatably attached to the periphery of disk 70 are two brackets 72, 74 which are in turn linked to locking pins 76, 78 which engage supports 80, 82 attached to door surround 12. Upper supports 80 are implemented as joints which permit rotation about a horizontal axis, in addition to the vertical hinge motion of locking pin 76 within the support. This effectively provides a universal joint in the form of a gimbal with two perpendicular hinge axes.

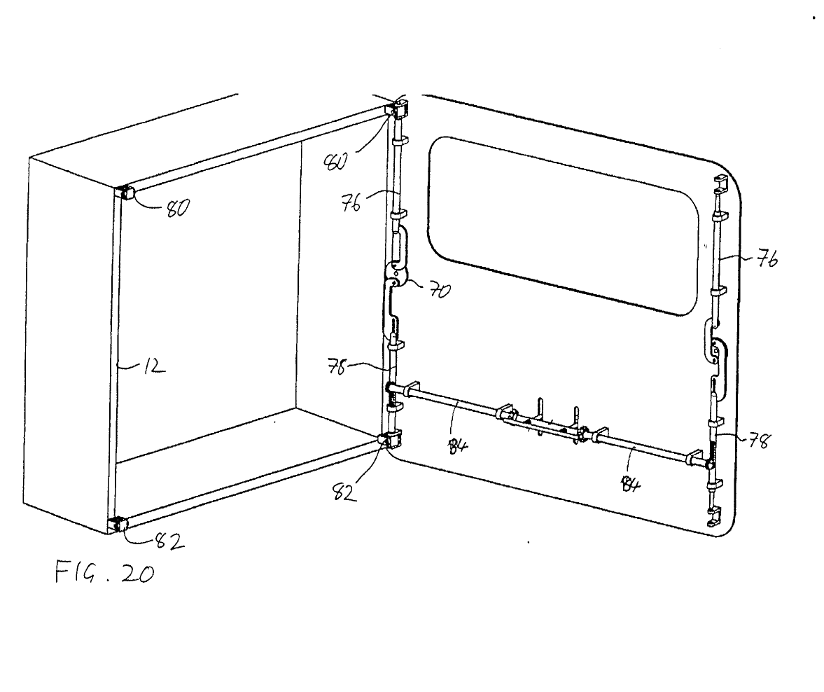

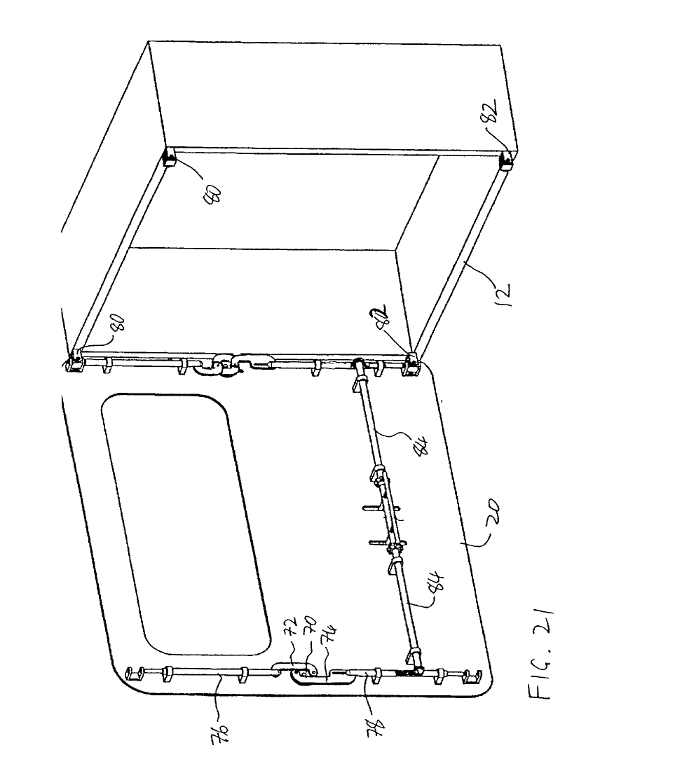

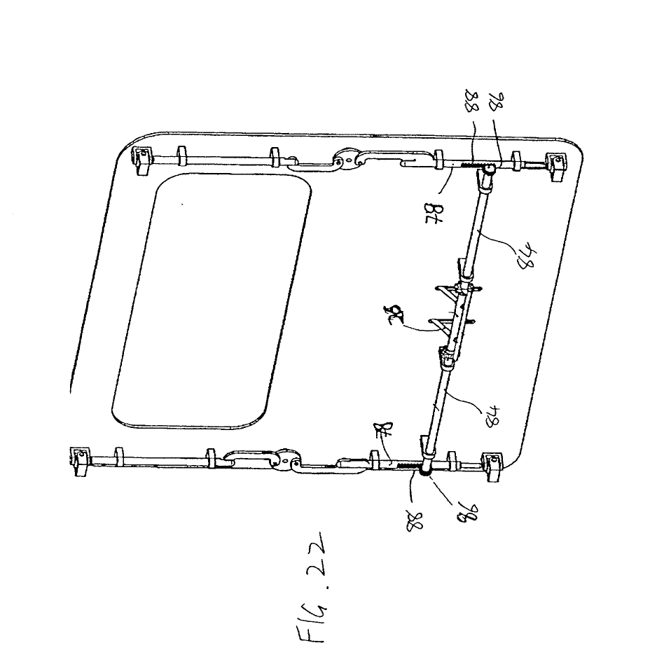

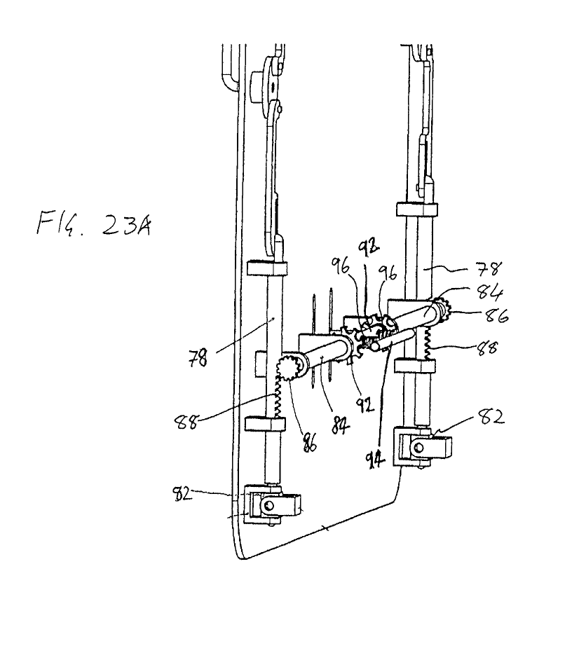

When handle 22 is turned, as shown in FIGS. 18A and 18B, disk 70 turns with it, thereby pulling brackets 72, 74 which draw locking pins 76, 78 out of engagement with supports 80, 82. The door is then free to open in a hinged rightward motion as shown in FIGS. 19 and 20 with locking pins 76, 78 and supports 80, 82 on the right-hand-side of the door forming the hinge. Similarly, operation of right handle 24 is effective to permit leftward hinged opening of the door as shown in FIG. 21.

Upward opening is achieved by operating lower handle 26 which rotates shafts 84 and the associated gear wheels 86. Gear wheels 86 are engaged with gear tracks 88 formed on lower locking pins 78, thereby raising locking pins 78 until they disengage from lower supports 82. This allows door 20 to be opened upwards, hinging around upper supports 80 as shown in FIG. 24.

Clearly, the parts of the opening mechanism actuated by each handle must be mechanically isolated such that lower locking pins 78 can be raised by operation of either lower handle 26 or one of side handles 22, 24 without the other handles being moved. Raising of locking pins 78 without actuation of side handles 22, 24 is here achieved by engaging each pin via a lateral projection engaged in an elongated vertical slot 90 formed in each lower brackets 74. This ensures that bracket 74 is effective to raise locking pin 78 when the side handle is actuated but also allows unimpeded raising of the locking pin when lower handle 26 is operated.

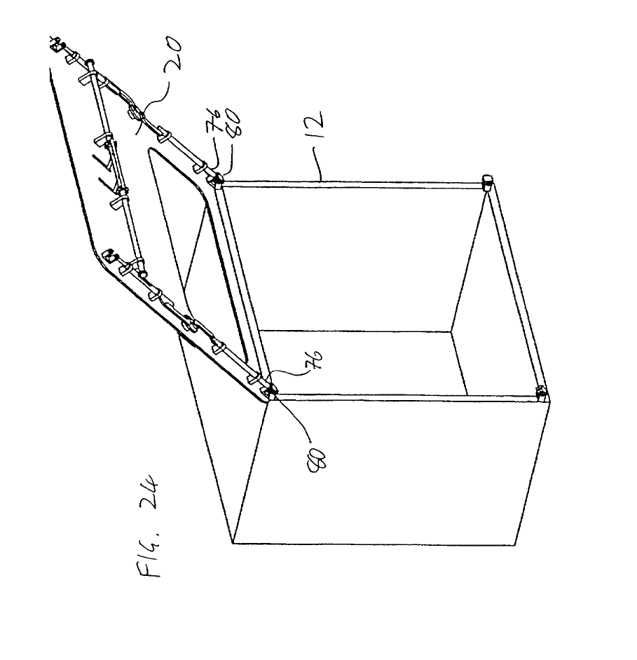

Isolation of lower handle 26 from the mechanism during operation of the side handles may be achieved in various different ways. By way of one simplistic example, FIGS. 23A and 23B show an implementation in which each shaft 84 has an engagement disk 92 within which a bar 94 is selectively engaged by pulling lower handle 26 against springs 96. In this configuration, bar 94 is normally disengaged, allowing free rotation of shafts 84 when the side handles are operated. During operation of lower handle 26, the handle is first pulled outwards to engage bar 94 in a socket of disk 92 and the handle is then turned to effect the opening action. Clearly, various arrangements of gears and one-way clutches or the like may be used to implement alternative mechanisms which will provide the required functionality, depending upon the specific design considerations for each application.

Here too, self-latching of the door when returned to its closed position may be achieved by a combination of spring biasing and appropriately angled abutment surfaces, as will be clear to one ordinarily skilled in the art.

It will be appreciated that the above descriptions are intended only to serve as examples, and that many other embodiments are possible within the spirit and the scope of the present invention.

What is claimed is:

1. A rear door assembly for a vehicle, the rear door assembly comprising:
(a) a rear door surround having an upper edge, a right-hand edge and a left-hand edge;
(b) a door; and
(c) a mechanical linkage interconnecting between said door surround and said door, said mechanical linkage being configured to selectively:
(i) retain said door in a closed state relative to said door surround,
(ii) permit opening of said door in a pivoting motion about a first hinge axis, and
(iii) permit opening of said door in a pivoting motion about a second hinge axis,
wherein said first and said second hinge axes are two different axes from the group made up of: a vertical axis adjacent to said right-hand edge; a vertical axis adjacent to said left-hand edge; and a horizontal axis adjacent to said upper edge.

2. The rear door assembly of claim 1, wherein said first hinge axis is said vertical axis adjacent to said right-hand edge and said second hinge axis is said vertical axis adjacent to said left-hand edge.

3. The rear door assembly of claim 1, wherein said door has a dimension D₁ as measured perpendicular to said first hinge axis and a dimension D₂ as measured perpendicular to said second hinge axis, said door including a first handle associated with the door at a position at least two thirds of D₁ away from said first hinge axis and configured to actuate said mechanical linkage so as to release said door from said closed state to permit opening of said door in a pivoting motion about said first hinge axis, said door further including a second handle associated with the door at a position at least two thirds of D₂ away from said second hinge axis and configured to actuate said mechanical linkage so as to release said door from said closed state to permit opening of said door in a pivoting motion about said second hinge axis.

4. The rear door assembly of claim 1, wherein said mechanical linkage includes an intermediate frame deployed between said door surround and said door, wherein said door is pivotally mounted to said intermediate frame so as to be pivotable about said first hinge axis and said intermediate frame is pivotally mounted to said door surround so as to be pivotable about said second hinge axis.

5. The rear door assembly of claim 4, wherein said second hinge axis is perpendicular to said first hinge axis.

6. The rear door assembly of claim 4, wherein said first hinge axis is said horizontal axis adjacent to said upper edge.

7. The rear door assembly of claim 6, wherein said mechanical linkage further includes at least one biasing mechanism deployed so as to bias said door relative to said intermediate frame to remain in an upwardly pivoted open position.

8. The rear door assembly of claim 4, wherein said second hinge axis is said horizontal axis adjacent to said upper edge.

9. The rear door assembly of claim 8, wherein said mechanical linkage further includes at least one biasing mechanism deployed so as to bias said intermediate frame relative to said door surround to remain in an upwardly pivoted open position.

10. The rear door assembly of claim 4, wherein said intermediate frame extends around substantially the entirety of said door surround.

11. The rear door assembly of claim 4, wherein said intermediate frame extends around only part of said door surround.

12. The rear door assembly of claim 4, wherein said intermediate frame is substantially hidden by said door when said door assumes said closed state.

13. The rear door assembly of claim 4, wherein said intermediate frame is implemented as a secondary door surround within which said door is positioned in said closed state.

14. The rear door assembly of claim 1, wherein said first hinge axis is a vertical axis adjacent to said right-hand edge, said second hinge axis is a vertical axis adjacent to said left-hand edge, and wherein said mechanical linkage is further configured to selectively permit opening of said door in a pivoting motion about a horizontal hinge axis adjacent to said upper edge.

15. The rear door assembly of claim 14, wherein said door has a dimension D₁ as measured perpendicular to said first and said second hinge axes and a dimension D₂ as measured perpendicular to said horizontal hinge axis, said door including a left handle associated with the door at a position at least two thirds of D₁ away from said first hinge axis and configured to actuate said mechanical linkage so as to release said door from said closed state to permit opening of said door in a pivoting motion about said first hinge axis, said door further including a right handle associated with the door at a position at least two thirds of D₁ away from said second hinge axis and configured to actuate said mechanical linkage so as to release said door from said closed state to permit opening of said door in a pivoting motion about said second hinge axis, and said door further including a bottom handle associated with the door at a position at least two thirds of D₂ away from said horizontal hinge axis and configured to actuate said mechanical linkage so as to release said door from said closed state to permit opening of said door in a pivoting motion about said horizontal hinge axis.

16. The rear door assembly of claim 14, wherein said mechanical linkage includes an intermediate frame deployed between said door surround and said door, wherein said door is pivotally mounted to said intermediate frame so as to be pivotable about said horizontal hinge axis and said intermediate frame is mounted to said door surround so as to be selectively pivotable about both said first hinge axis and said second hinge axis.

17. The rear door assembly of claim 14, wherein said mechanical linkage includes an intermediate frame deployed between said door surround and said door, wherein said door is mounted to said intermediate frame so as to be selectively pivotable about both said first hinge axis and said second hinge axis and said intermediate frame is pivotally mounted to said door surround so as to be pivotable about said horizontal hinge axis.
